(19) United States
(12) Patent Application Publication
(10) Pub. No.: US 2024/0163040 A1
(43) Pub. Date: May 16, 2024

(54) SYSTEMS AND METHODS FOR HANDLING SERVING AND NON-SERVING CELLS HAVING DIFFERENT FREQUENCY DOMAIN REFERENCE POINTS FOR REFERENCE SIGNAL SEQUENCE GENERATION

(71) Applicant: Telefonaktiebolaget LM Ericsson (publ), Stockholm (SE)

(72) Inventors: Jianwei Zhang, Solna (SE); Mattias Frenne, Uppsala (SE); Icaro Leonardo J. Da Silva, Solna (SE); Helka-Liina Määttänen, Espoo (FI)

(21) Appl. No.: 18/281,805

(22) PCT Filed: Mar. 23, 2022
(86) PCT No.: PCT/IB2022/052675

§ 371 Date: Sep. 13, 2023

Related U.S. Application Data
(60) Provisional application No. 63/164,878, filed on Mar. 23, 2021.

(51) Int. Cl. H04L 5/00

(52) U.S. Cl. CPC H04L 5/0048; H04L 5/0035

(57) ABSTRACT

Systems and methods for handling serving and non-serving cells having different frequency domain reference points for reference signal sequence generation are disclosed. In one embodiment, a method performed by a wireless communication device (WCD) comprises obtaining information about a frequency domain reference point to be used for one or more reference signals on a non-serving cell of the WCD and applying the information about the frequency domain reference point to be used for the one or more reference signals on the non-serving cell of the WCD to receive or transmit one or more reference signals on the non-serving cell of the WCD. In this manner, inter-cell operation is enabled for a UE for cases when a network deployment uses different reference points for reference signal sequence generation for different cells.

### RELATED APPLICATIONS

This application claims the benefit of provisional patent application Ser. No. 63/164,878, filed Mar. 23, 2021, the disclosure of which is hereby incorporated herein by reference in its entirety.

### TECHNICAL FIELD

The present disclosure relates to a cellular communications system and, more specifically, reference frequencies utilized as reference points for the generation of sequences for reference signals transmitted and received in a cellular communications system.

### BACKGROUND

Multi-Transmission/Reception Point (TRP) (also denoted as M-TRP or mTRP) inter-cell is one of the Release 17 Multiple Input Multiple Output (MIMO) further enhancement items in Third Generation Partnership Project (3GPP) RAN1. The goal is to extend the Release 16 MIMO M-TRP scheme, which supports only mTRP reception from TRPs in one cell, to supporting the inter-cell case, where a User Equipment (UE) can receive downlink transmission from multiple TRPs where at least one of the TRPs may be associated with a cell different from the serving cell of the UE, i.e. with a different Physical Cell Identity (ID) than the serving cell.

The Working Item (WI) description in 3GPP states, in pertinent part:
Enhancement on the support for multi-TRP deployment, targeting both FR1 and FR2:
   a. . . .
   b. Identify and specify QCL/TCI-related enhancements to enable inter-cell multi-TRP operations, assuming multi-Dci based multi-PDSCH reception

1 Resource Blocks and Common Resource Blocks and Point A

A resource block (RB) is defined as twelve consecutive subcarriers in the frequency domain. ‘Point A’ is used as frequency reference point and is utilized for indicating the frequency resources in 3GPP New Radio (NR). Point A is also used as the starting point for sequence generation. The center of subcarrier 0 of common resource block 0 (CRB0) for subcarrier spacing configuration p coincides with Point A. Hence, the CRB numbering starts at point A even if the actual used RB does not start at point A but at some positive frequency offset relative to point A.

To summarize, CRB numbering starts at point A such that CRBs are numbered from 0 and upwards in the frequency domain for subcarrier spacing configuration p starting at point A.

Physical resource blocks (PRBs) for subcarrier spacing p are defined within a bandwidth part (BWP) and numbered from 0 to N_{BWP_size}−1. In NR, a UE can be configured with up to four BWPs in the downlink with a single downlink BWP being active at a given time. The UE is not expected to receive Physical Downlink Shared Channel (PDSCH), Physical Downlink Control Channel (PDCCH), or Channel State Information Reference Signal (CSI-RS) (except for Radio Resource Management (RRM)) outside an active bandwidth part.

See FIG. 1 for further details about point A and how it is used.

For a Special Cell (SpCell) or Primary Cell (PCell), which is used for initial access, Point A is given by offsetoPointA as signaled in system information block 1 (SIB1) from the network to the UE. Otherwise, Point A is configured to the UE and is given by the Absolute Radio Frequency Channel Number (ARFCN) value parameter (i.e., ARFCN-ValueNR parameter) signaled in FrequencyInforDL using dedicated Radio Resource Control (RRC) signaling from the network to the UE.

2 CSI Reference Signals and Mapping of CSI-RS to Physical Resources

The UE can be configured with both non-zero-power CSI-RS (NZP CSI-RS) and zero-power CSI-RS (ZP CSI-RS). One or more NZP CSI-RS resource set configuration(s) may be configured by higher layer parameters CSI-ResourceConfigand NZP-CSI-RS-ResourceSet As described in 3GPP Technical Specification (TS) 38.211 v16.4.0, for each CSI-RS configured, the UE maps the sequence r(m) to resource elements (k,l), where k and l is the indexing of subcarrier and symbol to represent the frequency and time domain allocation of a resource element.

The reference point for k=0 is subcarrier 0 in CRB 0 which is determined by the Point A configuration. Hence, even though the actual transmitted CSI-RS sequence starts at some positive frequency offset relative to Point A, the generated sequence has its starting point (k=0) at Point A.

The starting position and number of the resource blocks in which the UE assumes that the CSI-RS is transmitted are given by the higher-layer parameters freqBand and density in the CSI-RS-ResourceMapping Information Element (IE) for the BWP given by the higher layer parameter BWP-Id in the CSI-ResourceConfigIE or given by the higher layer parameters nrofPRBs in the CSI-RS-CellMobilityIE where the startPRBgiven by csi-rs-MeasurementBW is relative to common resource block 0.

For reporting the Channel State Information (CSI), the UE is configured with CSI-ReportConfigfor a single downlink BWP associated with the BWP-Id configured in CSI-ResourceConfig. The bandwidth and initial CRB index of a CSI-RS resource within a BWP is determined based on parameters nrofRBsand startingRB which are configured as integer multiples of 4 RBs, as well as the starting RB for BWP start N_{BWP}^{start} and number of RBs as BWP size N_{BWP}^{size} of the associated BWP-Id. That the initial CRB index for CSI-RS mapping N_{initialRB} is applied with the larger value of startingRB and N_{BWP}^{start}, the bandwidth to map is applied with nrofRBs if the mapping is within the BWP, otherwise the bandwidth shall be N_{BWP}^{start}+N_{BWP}^{start}−N_{initialRB}.

“/” is a symbol index relative to the start of a slot. For periodic or semi-persistent CSI-RS resources, the transmitting slot of CSI-RS is determined by the periodicity T_{csi-rs} and slot offset T_{offset} obtained from the higher-layer parameter CSI-ResourcePeriodicityAndOffset or slotConfig.

Note that section 7.4.1.5.3 in 3GPP TS 38.211 describes the formulas and parameters to determine the mapping of the sequences.

3 Mapping of Other Reference Signals to Physical Resources

Here, examples of other reference signals with their mapping reference for resource element in a slot associated with CRB0, i.e. Point A configuration are listed. So, also for PDCCH Demodulation Reference Signal (DMRS), PDSCH DMRS, and PDSCH Phase Tracking Reference Signal (PTRS), the Point A of a cell is important to know to be able to receive the DMRS and PTRS sequence correctly. Furthermore, the PUSCH DMRS and Sounding Reference Signal (SRS) used at uplink transmission, the PUSCH DMRS and PDSCH DMRS used at sidelink, all refer to CRB0 position.

3.1 DMRS

3.1.1 DMRS Configuration for PDSCH

The mapping of DMRS to physical resources for PDSCH is defined in 3GPP TS 38.211 v16.4.0 Section 7.4.1.1.2, which is shown below in the following excerpt from 3GPP TS 38.211 v16.4.0.

**********START EXCERPT FROM 3GPP TS 38.211 v16.4.0**********

### 7.4.1.1.2 Mapping to Physical Resources

The UE shall assume the PDSCH DM-RS being mapped to physical resources according to configuration type 1 or configuration type 2 as given by the higher-layer parameter dmrs-Type.
The UE shall assume the sequence r(m) is scaled by a factor β_{PDSCH}^{DMRS} to conform with the transmission power specified in [6, TS 38.214] and mapped to resource elements (k, l)_{p,μ} according to

$${a}_{k , l}^{( p , μ )} = {β}_{PDSCH}^{DMRS} {w}_{f} ( {k}^{′} ) {w}_{t} ( {l}^{′} ) r ( 2 n + {k}^{′} ) \\ k = \{ \begin{matrix}4 n + 2 {k}^{′} + Δ & Configuration type 1 \\ 6 n + {k}^{′} + Δ & Configuration type 2\end{matrix} \\ {k}^{′} = 0 , 1 \\ l = \overline{l} + {l}^{′} \\ n = 0 , 1 , …$$

where w_{f}(k′), wₜ(l′), and Δ are given by Tables 7.4.1.1.2-1 and 7.4.1.1.2-2 and the following conditions are fulfilled:
   the resource elements are within the common resource blocks allocated for PDSCH transmission
The reference point for k is
   subcarrier 0 of the lowest-numbered resource block in CORESET 0 if the corresponding PDCCH is associated with CORESET 0 and Type0-PDCCH common search space and is addressed to SI-RNTI;
   otherwise, subcarrier 0 in common resource block 0
      [text omitted]

**********END EXCERPT FROM 3GPP TS 38.211 v16.4.0**********

3.1.2 DMRS Configuration for PDCCH

The mapping of DMRS to physical resources for PDCCH is defined in 3GPP TS 38.211 v16.4.0 Section 7.4.1.3.2, which is shown below in the following excerpt from 3GPP TS 38.211 v16.4.0

**********START EXCERPT FROM 3GPP TS 38.211 v16.4.0**********

### 7.4.1.3.2 Mapping to Physical Resources

The UE shall assume the sequence rₗ(m) is mapped to resource elements (k, l)_{p,μ} according to

a_{k,l}^{(p,μ)}=β_{DMRS}^{PDCCH}·rₗ(3n+k′)

k=nN_{sc}^{RB}+4k′+1

k′=0,1,2

n=0,1, . . .
where the following conditions are fulfilled
   they are within the resource element groups constituting the PDCCH the UE attempts to decode if the higher-layer parameter precoderGranularity equals sameAsREG-bundle,
   all resource-element groups within the set of contiguous resource blocks in the CORESET where the UE attempts to decode the PDCCH if the higher-layer parameter precoderGranularity equals allContiguousRBs.
The reference point for k is
   subcarrier 0 of the lowest-numbered resource block in the CORESET if the CORESET is configured by the PBCH or by the controlResourceSetZero field in the PDCCH-ConfigCommon IE,
   subcarrier 0 in common resource block 0 otherwise
      [text omitted]

**********END EXCERPT FROM 3GPP TS 38.211 v16.4.0**********

3.2 CSI-RS

The mapping of CSI-RS to physical resources is defined in 3GPP TS 38.211 v16.4.0 Section 7.4.1.5.3, which is shown below in the following excerpt from 3GPP TS 38.211 v16.4.0.

**********START EXCERPT FROM 3GPP TS 38.211 v16.4.0**********

### 7.4.1.5.3 Mapping to Physical Resources

For each CSI-RS configured, the UE shall assume the sequence r(m) being mapped to resources elements (k, l)_{p,μ} according to

$${a}_{k , l}^{( p , μ )} = {β}_{CSIRS} {w}_{f} ( {k}^{′} ) \cdot {w}_{t} ( {l}^{′} ) \cdot {r}_{l , {n}_{s , f}} ( {m}^{′} ) \\ {m}^{′} = ⌊ n α ⌋ + {k}^{′} + ⌊ \frac{\overline{k} ρ}{{N}_{sc}^{RB}} ⌋ \\ k = {nN}_{sc}^{RB} + \overline{k} + {k}^{′} \\ l = \overline{l} + {l}^{′} \\ α = \{ \begin{matrix}ρ & for X = 1 \\ 2 ρ & for X > 1\end{matrix} \\ n = 0 , 1 , …$$

when the following conditions are fulfilled:
   the resource element (k, l)_{p,μ} is within the resource blocks occupied by the CSI-RS resource for which the UE is configured
The reference point for k=0 is subcarrier 0 in common resource block 0.
   [text omitted]
The starting position and number of the resource blocks in which the UE shall assume that CSI-RS is transmitted are given by the higher-layer parameters freqBand and density in the CSI-RS-ResourceMapping IE for the bandwidth part given by the higher-layer parameter BWP-Id in the CSI-ResourceConfig IE or given by the higher-layer parameters nrofPRBs in the CSI-RS-CellMobility IE where the startPRB given by csi-rs-MeasurementBW is relative to common resource block 0.
   [text omitted]

**********END EXCERPT FROM 3GPP TS 38.211 v16.4.0**********

The frequency domain occupation of a CSI measurement resource (e.g., a NZP-CSI-RS resource or a CSI Interference Measurement (CSI-IM) resource) is configured via RRC information element CSI-FrequencyOccupation, which is defined in 3GPP TS 38.331 v16.3.1 as shown in the following excerpt.

**********START EXCERPT FROM 3GPP TS 38.331 v16.3.1**********

CSI-FrequencyOccupation
The IE CSI-FrequencyOccupation is used to configure the frequency domain occupation of a channel state information measurement resource (e.g. NZP-CSI-RS-Resource, CSI-IM-Resource).

### CSI-FrequencyOccupation Information Element

-- ASN1START
-- TAG-CSI-FREQUENCYOCCUPATION-START

| | |
|---|---|
| CSI-FrequencyOccupation ::= | SEQUENCE { |
| startingRB | INTEGER (0..maxNrofPhysicalResourceBlocks-1), |
| nrofRBs | INTEGER (24..maxNrofPhysicalResourceBlocksPlus1), |

...
}
-- TAG-CSI-FREQUENCYOCCUPATION-STOP
-- ASN1STOP

CSI-FrequencyOccupation field descriptions

nrofRBs
Number of PRBs across which this CSI resource spans. Only multiples of 4 are allowed. The smallest configurable
number is the minimum of 24 and the width of the associated BWP. If the configured value is larger than the width
of the corresponding BWP, the UE shall assume that the actual CSI-RS bandwidth is equal to the width of the BWP.
startingRB
PRB where this CSI resource starts in relation to common resource block #0 (CRB#0) on the common resource
block grid. Only multiples of 4 are allowed (0, 4, . . .)

**********END EXCERPT FROM 3GPP TS 38.331 v16.3.1**********

4 Configuration of SSB and BWP Relative to Point A P A Synchronization Signal Block (SSB) will have a non-negative frequency offset relative to Point A. So, when detecting an SSB, the UE can, by knowing this offset (given by SIB1), compute the frequency position for Point A.

Configuration perspective: The number of RBs per cell is a maximum 275 RBs, the offset indication range of SSB from point A is approximately 0-30 Megahertz (MHz) for FR1 (2199*15 khz), the BWP configuration is indicated in the Resource Indicator Value (RIV) with reference to the CRB0. For inter-frequency and intra-frequency configuration, the center frequency of SSBs is the same for intra-frequency inter-cell configuration, for inter frequency inter-cell, the center frequency of SSB is different.

In regard to SSB configuration, the following excerpts from 3GPP TS 38.331 v16.3.1 are provided.

**********START EXCERPTS FROM 3GPP TS 38.331 v16.3.1**********

SCS-SpecificCarrier
The IE SCS-SpecificCarrier provides parameters determining the location and width of the actual carrier or the carrier bandwidth. It is defined specifically for a numerology (subcarrier spacing (SCS)) and in relation (frequency offset) to Point A.

### SCS-SpecificCarrier Information Element

-- ASN1START
-- TAG-SCS-SPECIFICCARRIER-START

| | |
|---|---|
| SCS-SpecificCarrier ::= | SEQUENCE { |
| offsetToCarrier | INTEGER (0..2199), |
| subcarrierSpacing | SubcarrierSpacing, |
| carrierBandwidth | INTEGER (1..maxNrofPhysicalResourceBlocks), |

```
  ...,
  [[
```

| | |
|---|---|
| txDirectCurrentLocation | INTEGER (0..4095) |

OPTIONAL -- Need S
]]
}
-- TAG-SCS-SPECIFICCARRIER-STOP
-- ASN1STOP

SCS-SpecificCarrier field descriptions

carrierBandwidth
Width of this carrier in number of PRBs (using the subcarrierSpacing defined for this carrier) (see TS 38.211 [16],
clause 4.4.2).
offsetToCarrier
Offset in frequency domain between Point A (lowest subcarrier of common RB 0) and the lowest usable subcarrier
on this carrier in number of PRBs (using the subcarrierSpacing defined for this carrier). The maximum value
corresponds to 275*8-1. See TS 38.211 [16], clause 4.4.2.
txDirectCurrentLocation
Indicates the downlink Tx Direct Current location for the carrier. A value in the range 0 . . . 3299 indicates the
subcarrier index within the carrier. The values in the value range 3301 . . . 4095 are reserved and ignored by the UE.
If this field is absent for downlink within ServingCellConfigCommon and ServingCellConfigCommonSIB, the UE
assumes the default value of 3300 (i.e. “Outside the carrier”). (see TS 38.211 [16], clause 4.4.2). Network does not
configure this field via ServingCellConfig or for uplink carriers.
subcarrierSpacing
Subcarrier spacing of this carrier. It is used to convert the offsetToCarrier into an actual frequency. Only the values
15 kHz, 30 kHz or 60 kHz (FR1), and 60 kHz or 120 kHz (FR2) are applicable.

**********START NEXT EXCERPT FROM 3GPP TS 38.331 v16.3.1**********

BWP
The IE BWP is used to configure generic parameters of a bandwidth part as defined in TS 38.211 [16], clause 4.5, and TS 38.213 [13], clause 12.
For each serving cell the network configures at least an initial downlink bandwidth part and one (if the serving cell is configured with an uplink) or two (if using supplementary uplink (SUL)) initial uplink bandwidth parts. Furthermore, the network may configure additional uplink and downlink bandwidth parts for a serving cell.
The uplink and downlink bandwidth part configurations are divided into common and dedicated parameters.

### BWP Information Element

| -- ASN1START | |
|---|---|
| -- TAG-BWP-START | |
| BWP ::= | SEQUENCE { |
| locationAndBandwidth | INTEGER (0..37949), |
| subcarrierSpacing | SubcarrierSpacing, |
| cyclicPrefix | ENUMERATED { extended } |

OPTIONAL -- Need R
}
-- TAG-BWP-STOP
-- ASN1STOP

BWP field descriptions

cyclicPrefix
Indicates whether to use the extended cyclic prefix for this bandwidth part. If not set, the UE uses the normal cyclic
prefix. Normal CP is supported for all subcarrier spacings and slot formats. Extended CP is supported only for 60
kHz subcarrier spacing. (see TS 38.211 [16], clause 4.2)
locationAndBandwidth
Frequency domain location and bandwidth of this bandwidth part. The value of the field shall be interpreted as
resource indicator value (RIV) as defined TS 38.214 [19] with assumptions as described in TS 38.213 [13], clause
12, i.e. setting N_{BWP}^{size} = 275. The first PRB is a PRB determined by subcarrierSpacing of this BWP and
offsetToCarrier (configured in SCS-SpecificCarrier contained within FrequencyInfoDL/FrequencyInfoUL/
FrequencyInfoUL-SIB/FrequencyInfoDL-SIB within ServingCellConfigCommon/ServingCellConfigCommonSIB)
corresponding to this subcarrier spacing. In case of TDD, a BWP-pair (UL BWP and DL BWP with the same bwp-
Id) must have the same center frequency (see TS 38.213 [13], clause 12)
subcarrierSpacing
Subcarrier spacing to be used in this BWP for all channels and reference signals unless explicitly configured
elsewhere. Corresponds to subcarrier spacing according to TS 38.211 [16], table 4.2-1. The value kHz 15
corresponds to μ = 0, value kHz 30 corresponds to μ = 1, and so on. Only the values 15 kHz, 30 kHz, or 60 kHz
(FR1), and 60 kHz or 120 kHz (FR2) are applicable. For the initial DL BWP this field has the same value as the
field subCarrierSpacingCommon in MIB of the same serving cell.

**********END EXCERPTS FROM 3GPP TS 38.331 v16.3.1**********

### SUMMARY

Systems and methods for handling serving and non-serving cells having different frequency domain reference points for reference signal sequence generation are disclosed. In one embodiment, a method performed by a wireless communication device (WCD) comprises obtaining information about a frequency domain reference point to be used for one or more reference signals on a non-serving cell of the WCD and applying the information about the frequency domain reference point to be used for the one or more reference signals on the non-serving cell of the WCD to receive or transmit one or more reference signals on the non-serving cell of the WCD. In this manner, inter-cell operation is enabled for a UE for cases when a network deployment uses different reference points for reference signal sequence generation for different cells.

In one embodiment, a Synchronization Signal Block (SSB) frequency of the non-serving cell of the WCD is the same as a SSB frequency of a serving cell of the WCD. In one embodiment, the serving cell of the WCD is a Special Cell (SpCell) of the WCD, a Primary Cell (PCell) of the WCD, a Primary Secondary Cell (PSCell) of the WCD, or a Secondary Cell (SCell) of the WCD.

In one embodiment, the frequency domain reference point to be used for the one or more reference signals on the non-serving cell of the WCD is a Point A to be used for the one or more reference signals on the non-serving cell of the WCD. In one embodiment, a center subcarrier 0 of common resource block 0, CRB0, on the non-serving cell for a respective subcarrier spacing configuration coincides with the Point A to be used for the one or more reference signals on the non-serving cell of the WCD.

In one embodiment, the frequency domain reference point for the one or more reference signals on the non-serving cell of the WCD is different than a frequency domain reference point for the one or more reference signals on a serving cell of the WCD.

In one embodiment, the information about the frequency domain reference point to be used for the one or more reference signals on the non-serving cell of the WCD comprises the frequency domain reference point to be used for the one or more reference signals on the non-serving cell.

In one embodiment, the information about the frequency domain reference point to be used for the one or more reference signals on the non-serving cell of the WCD comprises an offset between the frequency domain reference point to be used for the one or more reference signals on the non-serving cell of the WCD and a frequency domain reference point to be used for the one or more reference signals on a serving cell of the WCD.

In one embodiment, the frequency domain reference point to be used for the one or more reference signals on the non-serving cell of the WCD is a common frequency domain reference point to be used for the one or more reference signals on both the non-serving cell of the WCD and a serving cell of the WCD. In one embodiment, the common frequency domain reference point is a common Point A, a Point A of the non-serving cell of the WCD is different than a Point A of a serving cell of the WCD, and the common Point A is different from the Point A of the non-serving cell, different from the Point A of the serving cell, or different from both the Point A of the non-serving cell and the Point A of the serving cell.

In one embodiment, obtaining the information about the frequency domain reference point to be used for the one or more reference signals on the non-serving cell of the WCD comprises receiving the information about the frequency domain reference point to be used for the one or more reference signals on the non-serving cell of the WCD via signaling from a network node. In one embodiment, the information about the frequency domain reference point to be used for the one or more reference signals on the non-serving cell of the WCD is signaled as part of a serving cell configuration of a serving cell of the WCD. In one embodiment, the information about the frequency domain reference point to be used for the one or more reference signals on the non-serving cell of the WCD is signaled outside of a serving cell configuration of a serving cell of the WCD. In one embodiment, the information about the frequency domain reference point to be used for the one or more reference signals on the non-serving cell of the WCD is signaled outside of a cell group configuration associated with a serving cell of the WCD.

In one embodiment, the information about the frequency domain reference point to be used for the one or more reference signals on the non-serving cell of the WCD comprises a common Point A to be applied by the WCD for both the non-serving cell of the WCD and a serving cell of the WCD, and obtaining the information about the frequency domain reference point to be used for the one or more reference signals on the non-serving cell of the WCD comprises determining the common Point A. In one embodiment, a Point A of the non-serving cell of the WCD is different than a Point A of a serving cell of the WCD, and the common Point A is different from the Point A of the non-serving cell, different from the Point A of the serving cell, or different from both the Point A of the non-serving cell and the Point A of the serving cell.

In one embodiment, the one or more reference signals are one or more reference signals other than a SSB.

In one embodiment, the one or more reference signals comprise: (a) a Channel State Information Reference Signal (CSI-RS), (b) a Demodulation Reference Signal (DMRS) for a Physical Downlink Control Channel (PDCCH), (c) a DMRS for a Physical Downlink Shared Channel (PDSCH), (d) a DMRS for a Physical Sidelink Shared Channel (PSSCH), (e) a DMRS for a Physical Sidelink Control Channel (PSCCH), (f) any combination of two or more of (a)-(e).

Corresponding embodiments of a WCD are also disclosed. In one embodiment, a WCD is adapted to obtain information about a frequency domain reference point to be used for one or more reference signals on a non-serving cell of the WCD and apply the information about the frequency domain reference point to be used for the one or more reference signals on the non-serving cell of the WCD to receive or transmit one or more reference signals on the non-serving cell of the WCD.

In another embodiment, a WCD comprises one or more transmitters, one or more receivers, and processing circuitry associated with the one or more transmitters and the one or more receivers. The processing circuitry is configured to cause the WCD to obtain information about a frequency domain reference point to be used for one or more reference signals on a non-serving cell of the WCD and apply the information about the frequency domain reference point to be used for the one or more reference signals on the non-serving cell of the WCD to receive or transmit one or more reference signals on the non-serving cell of the WCD.

Embodiments of a method performed by a network node are also disclosed. In one embodiment, a method performed by a network node comprises signaling, to a WCD, information about a frequency domain reference point to be used for one or more reference signals on a non-serving cell of the WCD.

Corresponding embodiments of a network node are also disclosed. In one embodiment, a network node is adapted to signal, to a WCD, information about a frequency domain reference point to be used for one or more reference signals on a non-serving cell of the WCD.

In another embodiment, a network node comprises processing circuitry configured to cause the network node to signal, to a WCD, information about a frequency domain reference point to be used for one or more reference signals on a non-serving cell of the WCD.

Embodiments of a method performed by first network node associated to a serving cell of a WCD are also disclosed. In one embodiment, the method comprises signaling, to a second network node associated to a non-serving cell of the WCD, information about a frequency domain reference point to be used for one or more reference signals on the serving cell of the WCD. Corresponding embodiments of the first network node are also disclosed.

Embodiments of a method performed by a second network node associated to a non-serving cell of a WCD are also disclosed. In one embodiment, the method comprises receiving, from a first network node associated to a serving cell of the WCD, information about a frequency domain reference point to be used for one or more reference signals on the serving cell of the WCD and applying the information about the frequency domain reference point to be used for the one or more reference signals on the serving cell of the WCD when transmitting or receiving one or more reference signals to or from the WCD on the non-serving cell of the WCD. Corresponding embodiments of the second network node are also disclosed.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates details about Point A and how it is used in a Third Generation Partnership Project (3GPP) New Radio (NR) network;

FIG. 2 illustrates one example of a cellular communications system in which embodiments of the present disclosure may be implemented;

FIG. 3 illustrate an example of an embodiment of the present disclosure in which a serving cell of a User Equipment (UE) and a non-serving cell of the UE have different Point As and in which information about the Point A of the non-serving cell of the UE is signaled to the UE in accordance with an embodiment of the present disclosure;

FIG. 4 illustrates the operation of a network node and a UE in accordance with an embodiment of the present disclosure in which the network node signals Point A information to the UE for a non-serving cell of the UE;

FIG. 5 illustrates an example of another embodiment of the present disclosure in which a UE obtains a common Point A for both the serving cell and a non-serving cell of the UE;

FIG. 6 illustrates the operation of a network node and a UE in accordance with an embodiment in which the UE obtains and applies a common Point A for both a serving cell and a non-serving cell of the UE;

FIG. 7 illustrates an example of another embodiment of the present disclosure in which network-based alignment of the Point A value used in the serving and non-serving cells of a UE is provided;

FIG. 8 illustrates the operation of a first network node, a second network node, and a UE in an embodiment in which network-based alignment of the Point A value used in the serving and non-serving cells of a UE is provided;

FIGS. 9, 10, 11 are schematic block diagrams of example embodiments of a network node;

FIGS. 12 and 13 are schematic block diagrams of example embodiments of a wireless communication device;

FIG. 14 illustrates an example embodiment of a communication system in which embodiments of the present disclosure may be implemented;

FIG. 15 illustrates example embodiments of the host computer, base station, and UE of FIG. 14; and

FIGS. 16, 17, 18, and 19 are flow charts that illustrate example embodiments of methods implemented in a communication system such as that of FIG. 14.

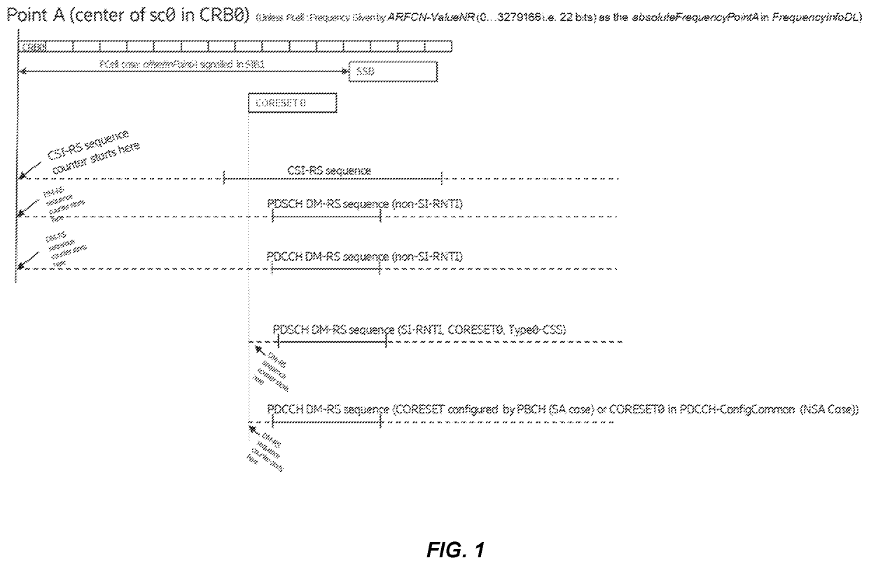

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). Detection of reference signals within one cell is supported in NR Release 15 and is based on the position of Point A for that cell, which is provided to the UE for each serving cell the UE is configured with (e.g., Special Cell (SpCell) or Secondary Cell (SCell) of the Master Cell Group (MCG) or the Secondary Cell Group)SCG)). Typically, part of the information needed in sequence generation of reference signals, including the exact resource elements (time and/or frequency resources) in which the sequence is transmitted, is derived from cell level configurations provided to the UE for the serving cells. Consequently, a UE cannot detect, e.g., a Channel State Information (CSI) Reference Signal (CSI-RS) for Layer 1 (L1) measurements (e.g., L1 Reference Signal Received Power (RSRP)) and/or CSI measurements (e.g., for Channel Quality Indicator (CQI), Precoding Matrix Indictor (PMI), Rank Indicator (RI), LI, CSI-RS Resource Indicator (CRI) reporting) associated to a neighbor cell, which is needed for a proper operation of inter-cell multi-TRP (M-TRP) and L1/Layer 2 (L2) centric inter-cell mobility, to support the network with L1 measurements of neighbor cells (which are not currently active serving cells). In RRC, for example, Point A for a serving cell can be obtained in ServingCellConfigCommon, possibly obtained from SIB1, as follows:

| | |
|---|---|
| ServingCellConfigCommonSIB ::= | SEQUENCE { |
| downlinkConfigCommon | DownlinkConfigCommonSIB, |

[...]
}

| | |
|---|---|
| DownlinkConfigCommonSIB :: = | SEQUENCE { |
| frequencyInfoDL | FrequencyInfoDL-SIB, |

[...]
}

| | |
|---|---|
| FrequencyInfoDL :: = | SEQUENCE { |
| absoluteFrequencySSB | ARFCN-ValueNR |

OPTIONAL, -- Cond SpCellAdd

| | |
|---|---|
| frequencyBandList | MultiFrequencyBandListNR, |
| absoluteFrequencyPointA | ARFCN-ValueNR, |
| scs-SpecificCarrierList | SEQUENCE (SIZE (1..maxSCSs)) OF |

SCS-SpecificCarrier,
...
}

In inter-cell operation, when a cell of physical cell ID which is different than a serving cell (e.g., SpCell or SCell) is to be supported for the UE downlink reception of a sequence transmitted from that cell, it is a problem that Point A of the neighbor cell is different from Point A of the serving cell. In this case, the base station (i.e., gNB in NR) and UE will have a different understanding of the frequency point (Point A) where the reference signal sequences start, i.e. k=0 or CRB0.

Certain aspects of the present disclosure and their embodiments may provide solutions to the aforementioned or other challenges.

Specification Change based Solution—Alignment from UE Side: In one embodiment, the UE is configured (e.g., by a network node such as a base station or gNB) with Point A information for each non-serving cell for which the UE is to perform L1 measurements (non-serving cells that are expected to be used for reception of data, e.g. PDCCH monitoring). For example, the Point A information may be added into the configuration of each non-serving cell. The configuration of each non-serving cell for which the UE is to perform L1 measurements can be provided in any of the following manners:
In one embodiment, the configuration of the non-serving cell (including the Point A information for the non-serving cell) is provided as part of a serving cell configuration for a serving cell of the UE that is in the same frequency as that non-serving cell. If the serving cell is a SpCell (e.g., Primary Cell (PCell) for a UE in single connectivity or Primary Secondary Cell (PSCell) for a UE in Multi-Radio Dual Connectivity), for example, the Point A information can be provided in a new version of the ServingCellConfigCommon for the SpCell, including Point A information for non-serving cell(s) in the same frequency of the SpCell. The UE also needs to have some form of identifier/index for the non-serving cell so that the UE can associate a given point A to a given non-serving cell being configured, as there may be multiple configured non-serving cells in the same frequency. One example of this signaling is shown below, where one or multiple Point A(s) is provided in the list/sequence frequencyInfoDL-NServCells-r17, as follows:

| | |
|---|---|
| ServingCellConfigCommon ::= | SEQUENCE { |

[...]

| | | |
|---|---|---|
| downlinkConfigCommon | DownlinkConfigCommon | OPTIONAL, -- Cond |

HOAndServCellAdd
[...]
}
DownlinkConfigCommon :: = SEQUENCE {

| | | |
|---|---|---|
| frequencyInfoDL | FrequencyInfoDL | OPTIONAL, -- Cond |

InterFreqHOAndServCellAdd
[...]

| | |
|---|---|
| frequencyInfoDL-NServCells-r17 | SEQUENCE (SIZE (1..K)) OF |

FrequencyInfoDL-NServCells OPTIONAL,
[...]
}

| | |
|---|---|
| FrequencyInfoDL-NServCells-r17 | SEQUENCE { |

[...]

| | |
|---|---|
| nonServingCellIndex | ServCellIndex, |
| absoluteFrequencyPointA | ARFCN-ValueNR, |

[...]
}
[...]
FrequencyInfoDL :: = SEQUENCE {
[...]

| | |
|---|---|
| absoluteFrequencyPointA | ARFCN-ValueNR, |

[...]
}

When the UE is configured with receiving control and/or data from a non-serving cell, the Point A of the non-serving cell, at least if different from the serving cell, is indicated to the UE. The UE applies the non-serving cell Point A when receiving signals associated with the non-serving cell, e.g., in order to determine where the signals are being transmitted so the UE can detect them in the right resource elements and perform the configured L1 measurements.
In another embodiment, the point A(s) for non-serving cell(s) is(are) provided outside of the serving cell configuration. For example, the point A(s) for non-serving cell(s) can be provided within a CellGroupConfig, as a way to indicate the point A(s) are non-serving cell configuration(s) for the MCG or the SCG. In this case, the configuration of these non-serving cells from which the UE can receive PDSCH is provided in the UE's RRC configuration, e.g. in IE CellGroupConfig but there is a distinguishment of the listen serving cells. In order to serve the UE from these non-serving cells, the UE needs certain configuration in addition to the point A. This certain configuration includes for example physical layer configuration as well as user plane and bearer configuration. Optionally, there is indication which serving cell configuration UE should follow apart from point-A to be able to receive data from the said non-serving cell.
In another embodiment, the point A(s) for non-serving cell(s) is(are) provided outside the CellGroupConfig, e.g., in the same level as an MCG or SCG configuration, as a way to indicate that non-serving cell configuration are valid for the MCG or the SCG. In this case, the configuration of these non-serving cells from which UE can receive PDSCH is provided in the UE's RRC configuration, e.g. in IE CellGroupConfig but there is a distinguishment of the listen serving cells. In order to serve the UE from these non-serving cells, the UE needs certain configuration in addition to the point A. This certain configuration includes for example physical layer configuration as well as user plane and bearer configuration. Optionally, there is indication which serving cell configuration UE should follow apart from point-A to be able to receive data from the said non-serving cell.

How to signal the Point A information for the non-serving cell(s) is subject to various embodiments. In one embodiment, the UE is configured with a frequency offset value of the non-serving cell Point A relative to the serving cell Point A. This may be done, for example, to indicate the non-serving cell Point A in the serving cell configuration. The advantage of such a solution is to avoid the repetition of multiple values, especially when the same point A can be assumed for serving cell and non-serving cells in the same frequency. With this option, it may be specified that the serving cell which Point A is used as a reference, also provides the needed physical layer configuration as well as user plane and bearer configuration in order to be able to receive data,

In one embodiment, a default configuration of Point A associated with a non-serving cell is assumed to be the same as that of the serving cell if the UE is not explicitly configured otherwise. That default value can be signaled by the absence of a parameter in the expected configuration for the non-serving cell, wherein the parameter can be the offset value of non-serving cell Point A relative to the serving cell Point A, or the parameter can be the absolute value of point A.

Implementation based Solution—Alignment from Network (e.g., gNB) Side: If Point A configuration of the non-serving cell is different from serving cell, the non-serving cell can be configured, or signaled, the Point A of the serving cell. The non-serving cell transmission towards the UE served by the serving cell then uses the serving cell Point A and the corresponding indexing.

In one embodiment, the BWP configuration to the UE of the serving cell is also indicated to the non-serving cell.

Note: The terminology “non-serving cell” is used herein to refer to a cell that can be used for data transmission and reception i.e. that can be associated to a reference signal (RS) associated to a Quasi Co-Located (QCL) source (in QCL-Info) that can be associated to at least one Transmission Configuration Indication (TCI) state the UE is configured with, wherein that “non-serving cell” is not one of the configured SpCell (according to Rel-16 definition of an SpCell) and that is not one of the configured SCells (according to Rel-16 definition of an SCell).

In one embodiment, the non-serving cell(s) is(are) in the same frequency as the SpCell, e.g. PCell or PSCell. In another embodiment, the non-serving cell(s) is(are) in the same frequency as the SCell. In another embodiment, the non-serving cell(s) is(are) in a non-serving frequency, i.e. not the same as the SpCell, not the same as an SCell. Being in the same frequency in this context can mean that they have the same SSB frequency.

Note: Even though the description provided herein refers to inter-cell M-TRP most of the time, embodiments of the solutions described herein are also applicable to L1/L2-centric inter-cell mobility, also being standardized in Rel-17. Fundamentally, the embodiments of the solutions described herein are applicable to any feature that requires the UE to detect reference signals of a non-serving cell that are not SSBs, as the SSBs do not require Point A to be detected and measured.

In one embodiment, a UE is configured by the network to support inter-cell operation, and information of the non-serving cell point A is signaled to the UE. A CSI-RS or DM-RS associated with a non-serving cell is defined as the CSI-RS/DM-RS that is configured with a QCL association of any type with an SSB which has a physical cell index (PCI) that is different from the serving cell PCI. The QCL association may be direct to the SSB, or the CSI-RS/DM-RS may be QCL with a TRS, where in turn the TRS is further QCL associated of any type with an SSB with a PCI different from the serving cell PCI. After receiving such information, the UE applies the Point A information of the non-serving cell when receiving downlink RS(s) on the non-serving cell. The downlink RS(s) may include, e.g., CSI-RS for CSI-reporting, DMRS for PDCCH, DMRS for PDSCH, PTRS for PDSCH, DMRS for PSSCH, and/or DMRS for PSCCH. The UE uses the Point A information of the non-serving cell for at least knowing the subcarrier which is defined as subcarrier zero (k=0) where the sequences start as k=0 coincides with Point A.

In one embodiment, if an CSI-RS configuration for CSI reporting is associated with the non-serving cell, the UE assumes the mapping of CSI-RS sequence with CRB indexing based on non-serving cell Point A. In on embodiment, the CSI-RS initial RB and CSI-RS bandwidth are determined based on the Point A information of the non-serving cell and, in some embodiments, startingRB, nrofRBs, and BWP-id in CSI-ResourceConfig, with BWP-id configuration associated with serving cell configuration.

In a further embodiment, if a non-serving cell is configured to the UE and the same Point A as for the serving cell is used for this non-serving cell, then Point A of the non-serving cell is not signaled to the UE. The UE then understands that the Point A can be assumed to be the same in the serving cell and the non-serving cell. Hence, in one embodiment, the default is that the UE can assume the same Point A, unless configured otherwise.

In an implementation-based solution from the network side, for the case that the non-serving cell and serving cell use different Point As, the Point A information of non-serving cell is not indicated to UE. Instead, the non-serving cell is informed by inter-gNB signaling or network configuration about the Point A of the serving cell for the UE that will be served by the non-serving cell. The non-serving cell then transmits RS(s) to the UE using the Point A of the UEs serving cell instead of the “true” Point A of the non-serving cell. Hence, from the UE perspective, it seems like the serving and non-serving cells have the same Point A, even though they do not. The transmission from non-serving cell to the UE then applies the Point A of the serving cell. This transmission may include, e.g., CSI-RS for CSI-reporting, DMRS for PDCCH, DMRS for PDSCH, DMRS for PSSCH, and/or DMRS for PSCCH.

In a further embodiment, the ARFCN of a non-serving cell is configured to the UE.

Certain embodiments may provide one or more of the following technical advantage(s). Embodiments described herein may allow support of inter-cell operation for a UE also for the cases when a network deployment use different Point As for different cells. Embodiments described herein may enable the UE to perform CSI-RS measurements for these non-serving cells with different Point As and perform L1 reporting to support L1/L2-centric inter-cell mobility and/or inter-cell multi-TRP operation. In addition to this, embodiments described herein may enable other features requiring these measurements such as CSI-RS measurements for L3 measurement reporting, Radio Link Monitoring (RLM) based on CSI-RSs for non-serving cells, and Beam Failure Detection monitoring based on CSI-RSs for non-serving cells.

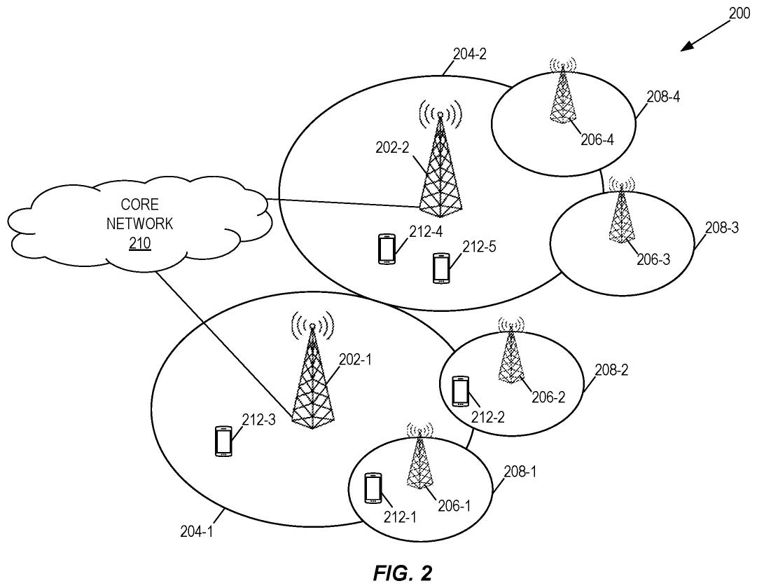

FIG. 2 illustrates one example of a cellular communications system 200 in which embodiments of the present disclosure may be implemented. In the embodiments described herein, the cellular communications system 200 is a 5G system (5GS) including a Next Generation RAN (NG-RAN) and a 5G Core (5GC); however, the present disclosure is not limited to the 5GS and may be used in other types of wireless or cellular communication systems. In this example, the RAN includes base stations 202-1 and 202-2, which in the 5GS include NR base stations (gNBs) and optionally next generation eNBs (ng-eNBs) (e.g., LTE RAN nodes connected to the 5GC), controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or RRHs, or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5G System (5GS) is referred to as the 5GC. The base stations 202 (and optionally the low power nodes 206) are connected to the core network 210.

The base stations 202 and the low power nodes 206 provide service to wireless communication devices (WCDs) 212-1 through 212-5 in the corresponding cells 204 and 208. The WCDs 212-1 through 212-5 are generally referred to herein collectively as WCDs 212 and individually as WCD 212. In the following description, the WCDs 212 are oftentimes UEs and as such sometimes referred to as UEs 212, but the present disclosure is not limited thereto.

In the following, embodiments related to the physical layer are mainly described, e.g., in terms of reference signal mapping, Point A indication, and UE capability.

### Reference Signal Mapping

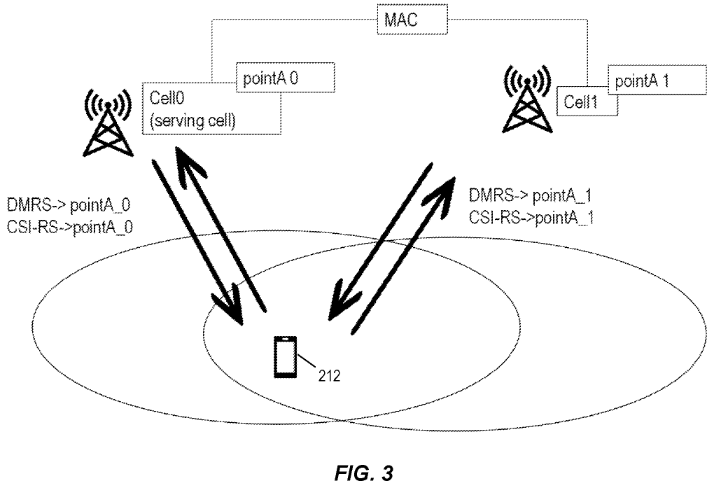

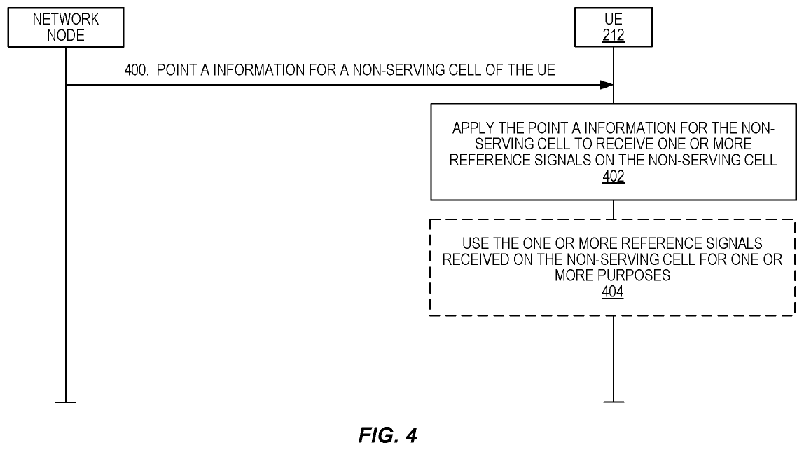

In one embodiment, non-serving cell Point A or offset to serving cell Point A is signaled to the UE 212, e.g., via higher layer configuration (e.g., via RRC signaling). The UE 212 assumes a mapping of a reference signal(s) from the non-serving cell using CRB indexing based on Point A of the non-serving cell. With this approach, the orthogonality of the reference signals in each cell is maintained, and more UEs can be scheduled on non-serving cell on same frequency resources at the same time. An illustration of one example of this embodiment with DMRS and CSI-RS transmission is shown in FIG. 3. As illustrated in FIG. 3, a serving cell (Cell0) of the UE 212 has a first Point A (PointA_0) and a non-serving cell (Cell1) of the UE 212 has a second Point A (PointA_1) that is different that PointA_0 of the serving cell (Cell0). As illustrated in FIG. 4, the Point A (PointA_1) of the non-serving cell (Cell1), or an offset between the Point A (PointA_1) of the non-serving cell (Cell1) and the Point A (PointA_0) of the serving cell (Cell0), is signaled to the UE 212 from a network node (e.g., base station 202 serving the serving cell (Cell_0)) (step 400). Various mechanisms by which this information may be signaled to the UE 212 either as part of the serving cell configuration for the serving cell (Cell0) or external to the serving cell configuration for the serving cell (Cell0) or external to the cell group configuration are described herein and equally applicable here. The UE 212 then applies the Point A (PointA_1) of the non-serving cell to receive one or more reference signals on the non-serving cell as described herein (step 402). The UE 212 uses the received reference signal(s) on the non-serving cell for one or more purposes (e.g., uses received CSI-RS on the non-serving cell for CSI measurement and reporting, uses DMRS for PDCCH reception on the non-serving cell, uses DMRS for PDSCH reception on the non-serving cell, uses DMRS for PSSCH reception, and/or uses DMRS for PSCCH reception) (step 404).

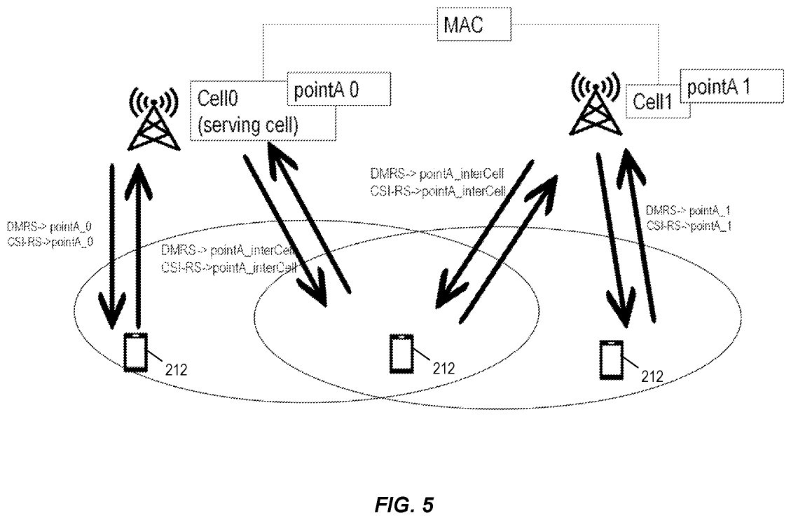

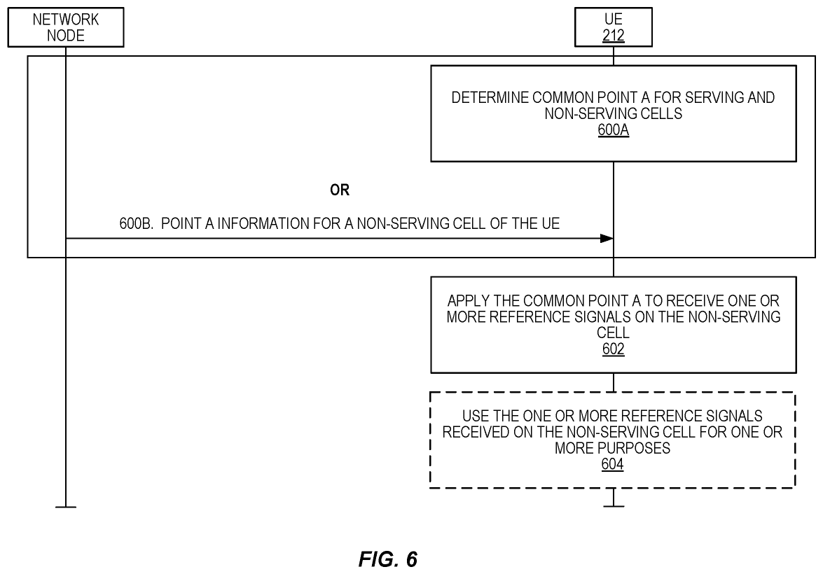

In another embodiment, the CRB0 for resource allocation is aligned with the lowest (lowest to avoid negative k value) Point A in frequency of the serving cell and non-serving cell, and a new indexing is indicated for interCell-CRB. Indexing of InterCell-CRB is used when mapping the reference signal on the corresponding RBs for serving cell and non-serving cell. The common Point A of the serving cell and the non-serving cell can also be explicitly signaled to UE 212 via higher layer configuration. The UE 212 applies the mapping based on the common Point A. With this approach, the orthogonality of reference signals on the same RE from different cells is maintained, which increases the possibility of high data throughput of the serving UE. An illustration of one example of this embodiment with DMRS and CSI-RS transmission is shown in FIG. 5. As illustrated in FIG. 5, a serving cell (Cell0) of the UE 212 has a first Point A (PointA_0) and a non-serving cell (Cell1) of the UE 212 has a second Point A (PointA_1) that is different that PointA_0 of the serving cell (Cell0). A common Point A (pointA_interCell) is either derived by the UE 212 or signaled to the UE 212 from a network node (e.g., a base station 202 that serves the serving cell (Cell0) of the UE 212). Note that PointA_0 may be used for other UEs served by Cell0 and PointA_1 may be used for other UEs served by Cell 1. As illustrated in FIG. 6, a common Point A (pointA_interCell) is either derived by the UE 212 (e.g., as the lowest Point A in frequency from among the Point As of the serving and non-serving cells) (step 600A) or the common Point A is signaled to the UE 212 from a network node (step 600B). The UE 212 then applies the common Point A to receive one or more reference signals on the non-serving cell as described herein (and optionally to receive one or more reference signals on the serving cell) (step 602). The UE 212 uses the received reference signal(s) on the non-serving cell for one or more purposes (e.g., uses received CSI-RS on the non-serving cell for CSI measurement and reporting, uses DMRS for PDCCH reception on the non-serving cell, uses DMRS for PDSCH reception on the non-serving cell, uses DMRS for PSSCH reception, and/or uses DMRS for PSCCH reception) (step 604).

In one embodiment, switching between the above two methods (i.e., between the method of FIGS. 3 and 4 and the method of FIGS. 5 and 6) may be based on higher layer signaling (e.g., RRC signaling).

In one embodiment, the InterCell-CRB is only applied on mapping of reference signals. The BWP configuration associated with a non-serving cell uses the CRB0 of the serving cell.

In one embodiment, reference signal associated with non-serving cell is allowed to apply negative integer value of k, with k=0 referring to CRB 0 of serving cell.

### Indication and Configuration of Point A

### Indicate Explicit Point A Position

In one embodiment, an offset to point A for the non-serving cell is explicitly indicated to the UE 212.

From resource grid perspective, even with different Point A positions, the resource grid is aligned among the serving and non-serving cells. The offset or the difference between the Point A of the serving cell and the Point A of the non-serving cell is, in one embodiment, a multiple of X RBs (e.g., X=4) in order to align the common resource grid if serving cell and non-serving cells are of same numerology. The indexing of CRB for different serving cell may be different because of different Point A configuration, but the grid for RBG group maintains the same.

### Network Based (e.g., gNB Based) Aligning

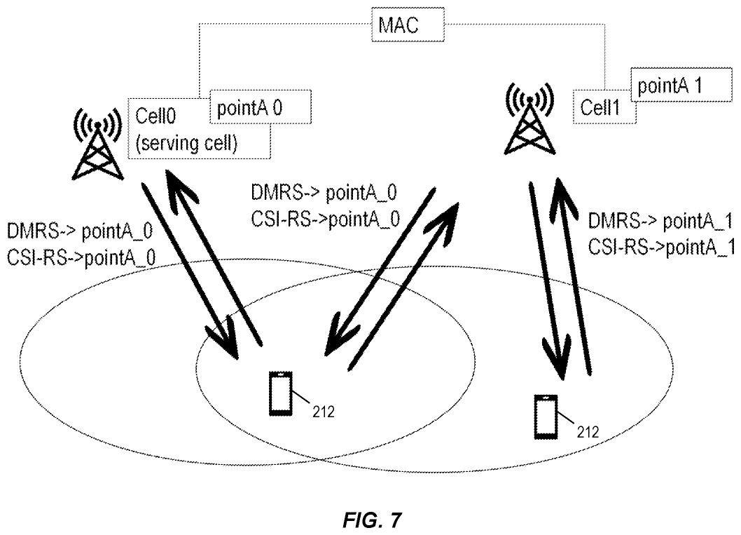

In one embodiment, the network (e.g., network node(s) or gNB(s)) align the Point A of non-serving cell with the Point A of the serving cell when transmitting downlink signals to the UE 212. In one embodiment, this is done by a network node (e.g., base station 202 such as a gNB) that serves the serving cell of the UE 212 sending the Point A information of the serving cell to a network node (e.g., base station 202 such as a gNB) that serves the non-serving cell of the UE 212, where the network node that serves the non-serving cell then applies the Point A of the serving cell of the UE 212 when transmitting one or more downlink reference signals to the UE 212 on the non-serving cell, or vice versa. In one embodiment, the BWP configuration of serving cell is also transmitted to the non-serving cell such that the CSI-RS is mapped accordingly. An illustration of one example of this embodiment with DMRS and CSI-RS transmission is shown in FIG. 7. As illustrated in FIG. 7, a serving cell (Cell0) of the UE 212 has a first Point A (PointA_0) and a non-serving cell (Cell1) of the UE 212 has a second Point A (PointA_1) that is different that PointA_0 of the serving cell (Cell0). PointA_0 of the serving cell (Cell0) is signaled (e.g., via inter-node or inter-base station signaling) from the network node that serves Cell0 to the network node that serves Cell1. PointA_1 is then applied on the non-serving cell (Cell1) to transmit downlink reference signals to the UE 212, e.g., such that to the UE 212 the non-serving cell (Cell1) appears to use the same Point A as the serving cell (Cell0).

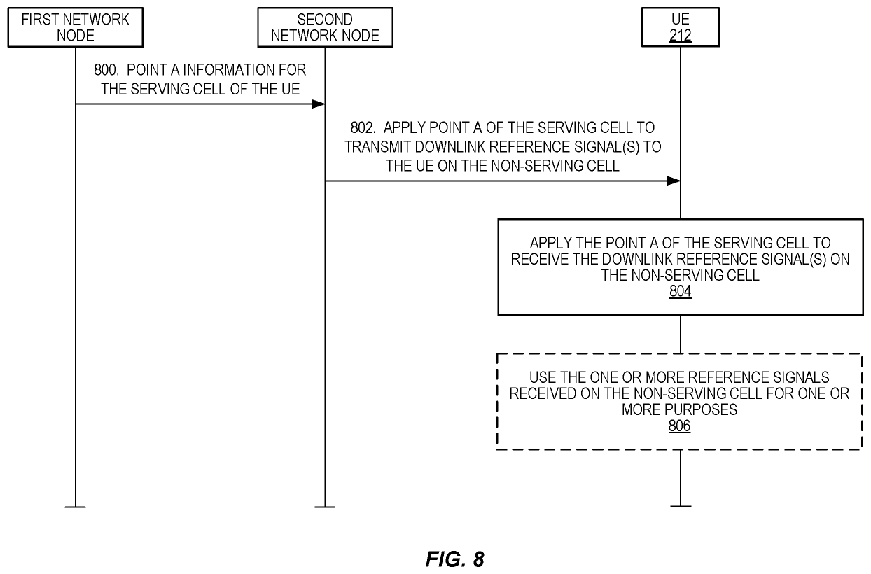

One example procedure for this embodiment is illustrated in FIG. 8. As illustrated in FIG. 8, a first network node that serves the serving cell (Cell0) of the UE 212 signals its Point A (PointA_0) to a second network node that serves the non-serving cell (Cell1) of the UE 212 (step 800). The second network node applies the Point A (PointA_0) of the serving cell when transmitting one or more downlink reference signals to the UE 212 on the non-serving cell (Cell1) of the UE 212 (step 802). The UE 212 then applies the Point A of the serving cell to receive the one or more reference signals on the non-serving cell as described herein (and optionally to receive one or more reference signals on the serving cell) (step 804). The UE 212 uses the received reference signal(s) on the non-serving cell for one or more purposes (e.g., uses received CSI-RS on the non-serving cell for CSI measurement and reporting, uses DMRS for PDCCH reception on the non-serving cell, uses DMRS for PDSCH reception on the non-serving cell, uses DMRS for PSSCH reception, and/or uses DMRS for PSCCH reception) (step 806).

### Further Description

Note: Although the description herein focuses on downlink, the same concepts are also applicable for uplink and further for sidelink.

Non-serving cell(s) belonging to a different band or different numerology can be a prerequisite for a different Point As being configured to the UE 212. A UE that reports supporting carrier aggregation of X carriers in its capability information may expect to be configured with maximum X-Y carriers, if it is also configured with inter-cell M-TRP with Y non-serving cells.

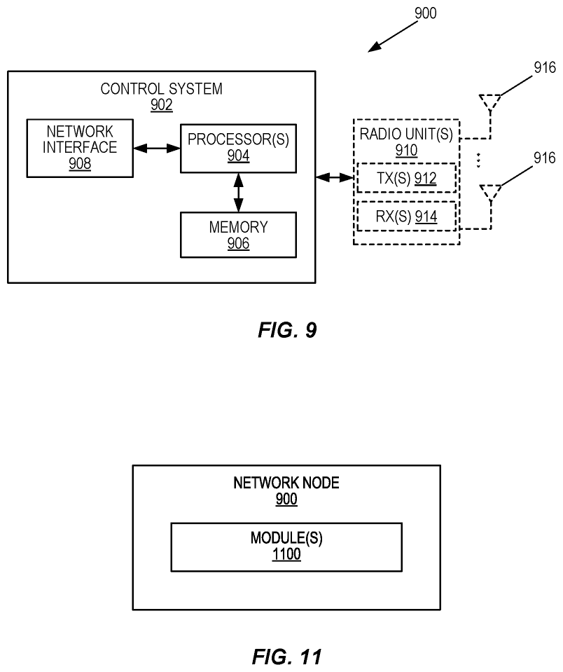

FIG. 9 is a schematic block diagram of a network node 900 according to some embodiments of the present disclosure. Optional features are represented by dashed boxes. The network node 900 may be, for example, a base station 202 or 206 or a network node that implements all or part of the functionality of the base station 202 or gNB described herein. As illustrated, the network node 900 includes a control system 902 that includes one or more processors 904 (e.g., Central Processing Units (CPUs), Application Specific Integrated Circuits (ASICs), Field Programmable Gate Arrays (FPGAs), and/or the like), memory 906, and a network interface 908. The one or more processors 904 are also referred to herein as processing circuitry. In addition, the network node 900 may include one or more radio units 910 that each includes one or more transmitters 912 and one or more receivers 914 coupled to one or more antennas 916. The radio units 910 may be referred to or be part of radio interface circuitry. In some embodiments, the radio unit(s) 910 is external to the control system 902 and connected to the control system 902 via, e.g., a wired connection (e.g., an optical cable). However, in some other embodiments, the radio unit(s) 910 and potentially the antenna(s) 916 are integrated together with the control system 902. The one or more processors 904 operate to provide one or more functions of the network node 900 as described herein (e.g., one or more functions of a network node, base station, or gNB described herein, e.g., with respect to FIGS. 3, 4, 5, 6, 7, and/or 8). In some embodiments, the function(s) are implemented in software that is stored, e.g., in the memory 906 and executed by the one or more processors 904.

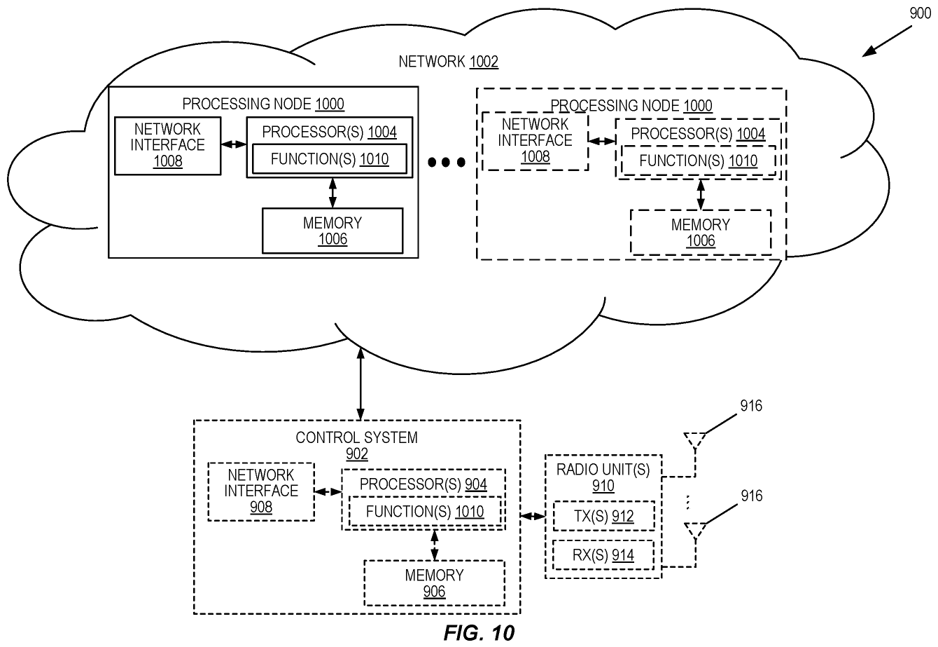

FIG. 10 is a schematic block diagram that illustrates a virtualized embodiment of the network node 900 according to some embodiments of the present disclosure. Again, optional features are represented by dashed boxes. As used herein, a “virtualized” network node is an implementation of the network node 900 in which at least a portion of the functionality of the network node 900 is implemented as a virtual component(s) (e.g., via a virtual machine(s) executing on a physical processing node(s) in a network(s)). As illustrated, in this example, the network node 900 may include the control system 902 and/or the one or more radio units 910, as described above. The control system 902 may be connected to the radio unit(s) 910 via, for example, an optical cable or the like. The network node 900 includes one or more processing nodes 1000 coupled to or included as part of a network(s) 1002. If present, the control system 902 or the radio unit(s) are connected to the processing node(s) 1000 via the network 1002. Each processing node 1000 includes one or more processors 1004 (e.g., CPUs, ASICs, FPGAs, and/or the like), memory 1006, and a network interface 1008.

In this example, functions 1010 of the network node 900 described herein (e.g., one or more functions of a network node, base station, or gNB described herein, e.g., with respect to FIGS. 3, 4, 5, 6, 7, and/or 8) are implemented at the one or more processing nodes 1000 or distributed across the one or more processing nodes 1000 and the control system 902 and/or the radio unit(s) 910 in any desired manner. In some particular embodiments, some or all of the functions 1010 of the network node 900 described herein are implemented as virtual components executed by one or more virtual machines implemented in a virtual environment(s) hosted by the processing node(s) 1000. As will be appreciated by one of ordinary skill in the art, additional signaling or communication between the processing node(s) 1000 and the control system 902 is used in order to carry out at least some of the desired functions 1010. Notably, in some embodiments, the control system 902 may not be included, in which case the radio unit(s) 910 communicate directly with the processing node(s) 1000 via an appropriate network interface(s).

In some embodiments, a computer program including instructions which, when executed by at least one processor, causes the at least one processor to carry out the functionality of the network node 900 or a node (e.g., a processing node 1000) implementing one or more of the functions 1010 of the network node 900 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the network node 900 according to some other embodiments of the present disclosure. The radio access node 900 includes one or more modules 1100, each of which is implemented in software. The module(s) 1100 provide the functionality of the network node 900 described herein. This discussion is equally applicable to the processing node 1000 of FIG. 10 where the modules 1100 may be implemented at one of the processing nodes 1000 or distributed across multiple processing nodes 1000 and/or distributed across the processing node(s) 1000 and the control system 902.

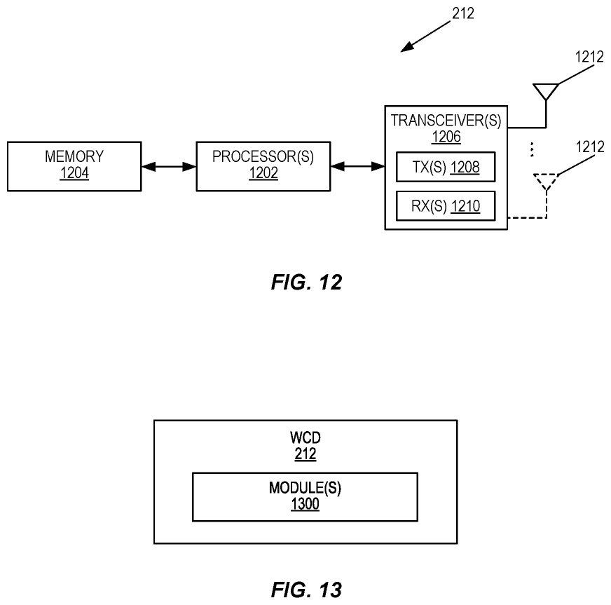

FIG. 12 is a schematic block diagram of a WCD 212 (e.g., a UE 212) according to some embodiments of the present disclosure. As illustrated, the WCD 212 includes one or more processors 1202 (e.g., CPUs, ASICs, FPGAs, and/or the like), memory 1204, and one or more transceivers 1206 each including one or more transmitters 1208 and one or more receivers 1210 coupled to one or more antennas 1212. The transceiver(s) 1206 includes radio-front end circuitry connected to the antenna(s) 1212 that is configured to condition signals communicated between the antenna(s) 1212 and the processor(s) 1202, as will be appreciated by on of ordinary skill in the art. The processors 1202 are also referred to herein as processing circuitry.

The transceivers 1206 are also referred to herein as radio circuitry. In some embodiments, the functionality of the WCD 212 described above may be fully or partially implemented in software that is, e.g., stored in the memory 1204 and executed by the processor(s) 1202. Note that the WCD 212 may include additional components not illustrated in FIG. 12 such as, e.g., one or more user interface components (e.g., an input/output interface including a display, buttons, a touch screen, a microphone, a speaker(s), and/or the like and/or any other components for allowing input of information into the WCD 212 and/or allowing output of information from the WCD 212), a power supply (e.g., a battery and associated power circuitry), etc.

In some embodiments, a computer program including instructions which, when executed by at least one processor, causes the at least one processor to carry out the functionality of the WCD 212 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the WCD 212 according to some other embodiments of the present disclosure. The WCD 212 includes one or more modules 1300, each of which is implemented in software. The module(s) 1300 provide the functionality of the WCD 212 described herein.

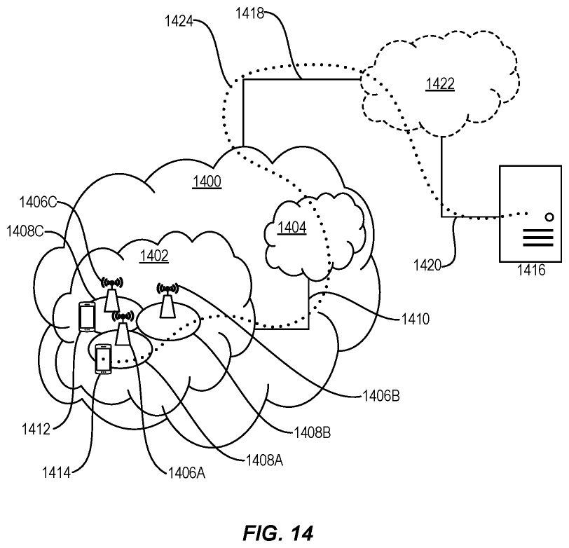

With reference to FIG. 14, in accordance with an embodiment, a communication system includes a telecommunication network 1400, such as a 3GPP-type cellular network, which comprises an access network 1402, such as a RAN, and a core network 1404. The access network 1402 comprises a plurality of base stations 1406A, 1406B, 1406C, such as Node Bs, eNBs, gNBs, or other types of wireless Access Points (APs), each defining a corresponding coverage area 1408A, 1408B, 1408C. Each base station 1406A, 1406B, 1406C is connectable to the core network 1404 over a wired or wireless connection 1410. A first UE 1412 located in coverage area 1408C is configured to wirelessly connect to, or be paged by, the corresponding base station 1406C. A second UE 1414 in coverage area 1408A is wirelessly connectable to the corresponding base station 1406A. While a plurality of UEs 1412, 1414 are illustrated in this example, the disclosed embodiments are equally applicable to a situation where a sole UE is in the coverage area or where a sole UE is connecting to the corresponding base station 1406.

The telecommunication network 1400 is itself connected to a host computer 1416, which may be embodied in the hardware and/or software of a standalone server, a cloud-implemented server, a distributed server, or as processing resources in a server farm. The host computer 1416 may be under the ownership or control of a service provider, or may be operated by the service provider or on behalf of the service provider. Connections 1418 and 1420 between the telecommunication network 1400 and the host computer 1416 may extend directly from the core network 1404 to the host computer 1416 or may go via an optional intermediate network 1422. The intermediate network 1422 may be one of, or a combination of more than one of, a public, private, or hosted network; the intermediate network 1422, if any, may be a backbone network or the Internet; in particular, the intermediate network 1422 may comprise two or more sub-networks (not shown).

The communication system of FIG. 14 as a whole enables connectivity between the connected UEs 1412, 1414 and the host computer 1416. The connectivity may be described as an Over-the-Top (OTT) connection 1424. The host computer 1416 and the connected UEs 1412, 1414 are configured to communicate data and/or signaling via the OTT connection 1424, using the access network 1402, the core network 1404, any intermediate network 1422, and possible further infrastructure (not shown) as intermediaries. The OTT connection 1424 may be transparent in the sense that the participating communication devices through which the OTT connection 1424 passes are unaware of routing of uplink and downlink communications. For example, the base station 1406 may not or need not be informed about the past routing of an incoming downlink communication with data originating from the host computer 1416 to be forwarded (e.g., handed over) to a connected UE 1412. Similarly, the base station 1406 need not be aware of the future routing of an outgoing uplink communication originating from the UE 1412 towards the host computer 1416.

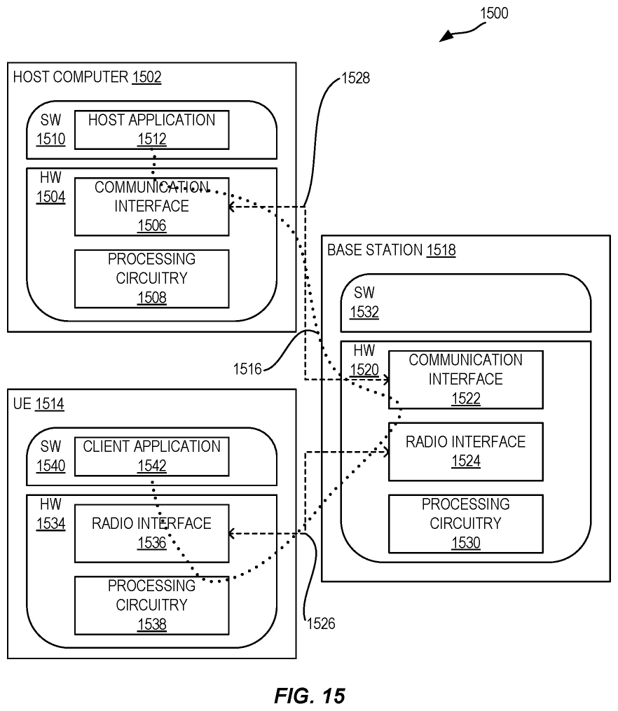

Example implementations, in accordance with an embodiment, of the UE, base station, and host computer discussed in the preceding paragraphs will now be described with reference to FIG. 15. In a communication system 1500, a host computer 1502 comprises hardware 1504 including a communication interface 1506 configured to set up and maintain a wired or wireless connection with an interface of a different communication device of the communication system 1500. The host computer 1502 further comprises processing circuitry 1508, which may have storage and/or processing capabilities. In particular, the processing circuitry 1508 may comprise one or more programmable processors, ASICs, FPGAs, or combinations of these (not shown) adapted to execute instructions. The host computer 1502 further comprises software 1510, which is stored in or accessible by the host computer 1502 and executable by the processing circuitry 1508. The software 1510 includes a host application 1512. The host application 1512 may be operable to provide a service to a remote user, such as a UE 1514 connecting via an OTT connection 1516 terminating at the UE 1514 and the host computer 1502. In providing the service to the remote user, the host application 1512 may provide user data which is transmitted using the OTT connection 1516.

The communication system 1500 further includes a base station 1518 provided in a telecommunication system and comprising hardware 1520 enabling it to communicate with the host computer 1502 and with the UE 1514. The hardware 1520 may include a communication interface 1522 for setting up and maintaining a wired or wireless connection with an interface of a different communication device of the communication system 1500, as well as a radio interface 1524 for setting up and maintaining at least a wireless connection 1526 with the UE 1514 located in a coverage area (not shown in FIG. 15) served by the base station 1518. The communication interface 1522 may be configured to facilitate a connection 1528 to the host computer 1502. The connection 1528 may be direct or it may pass through a core network (not shown in FIG. 15) of the telecommunication system and/or through one or more intermediate networks outside the telecommunication system. In the embodiment shown, the hardware 1520 of the base station 1518 further includes processing circuitry 1530, which may comprise one or more programmable processors, ASICs, FPGAs, or combinations of these (not shown) adapted to execute instructions. The base station 1518 further has software 1532 stored internally or accessible via an external connection.

The communication system 1500 further includes the UE 1514 already referred to. The UE's 1514 hardware 1534 may include a radio interface 1536 configured to set up and maintain a wireless connection 1526 with a base station serving a coverage area in which the UE 1514 is currently located. The hardware 1534 of the UE 1514 further includes processing circuitry 1538, which may comprise one or more programmable processors, ASICs, FPGAs, or combinations of these (not shown) adapted to execute instructions. The UE 1514 further comprises software 1540, which is stored in or accessible by the UE 1514 and executable by the processing circuitry 1538. The software 1540 includes a client application 1542. The client application 1542 may be operable to provide a service to a human or non-human user via the UE 1514, with the support of the host computer 1502. In the host computer 1502, the executing host application 1512 may communicate with the executing client application 1542 via the OTT connection 1516 terminating at the UE 1514 and the host computer 1502. In providing the service to the user, the client application 1542 may receive request data from the host application 1512 and provide user data in response to the request data. The OTT connection 1516 may transfer both the request data and the user data. The client application 1542 may interact with the user to generate the user data that it provides.

It is noted that the host computer 1502, the base station 1518, and the UE 1514 illustrated in FIG. 15 may be similar or identical to the host computer 1416, one of the base stations 1406A, 1406B, 1406C, and one of the UEs 1412, 1414 of FIG. 14, respectively. This is to say, the inner workings of these entities may be as shown in FIG. 15 and independently, the surrounding network topology may be that of FIG. 14.

In FIG. 15, the OTT connection 1516 has been drawn abstractly to illustrate the communication between the host computer 1502 and the UE 1514 via the base station 1518 without explicit reference to any intermediary devices and the precise routing of messages via these devices. The network infrastructure may determine the routing, which may be configured to hide from the UE 1514 or from the service provider operating the host computer 1502, or both. While the OTT connection 1516 is active, the network infrastructure may further take decisions by which it dynamically changes the routing (e.g., on the basis of load balancing consideration or reconfiguration of the network).

The wireless connection 1526 between the UE 1514 and the base station 1518 is in accordance with the teachings of the embodiments described throughout this disclosure. One or more of the various embodiments improve the performance of OTT services provided to the UE 1514 using the OTT connection 1516, in which the wireless connection 1526 forms the last segment.

A measurement procedure may be provided for the purpose of monitoring data rate, latency, and other factors on which the one or more embodiments improve. There may further be an optional network functionality for reconfiguring the OTT connection 1516 between the host computer 1502 and the UE 1514, in response to variations in the measurement results. The measurement procedure and/or the network functionality for reconfiguring the OTT connection 1516 may be implemented in the software 1510 and the hardware 1504 of the host computer 1502 or in the software 1540 and the hardware 1534 of the UE 1514, or both. In some embodiments, sensors (not shown) may be deployed in or in association with communication devices through which the OTT connection 1516 passes; the sensors may participate in the measurement procedure by supplying values of the monitored quantities exemplified above, or supplying values of other physical quantities from which the software 1510, 1540 may compute or estimate the monitored quantities. The reconfiguring of the OTT connection 1516 may include message format, retransmission settings, preferred routing, etc.; the reconfiguring need not affect the base station 1518, and it may be unknown or imperceptible to the base station 1518. Such procedures and functionalities may be known and practiced in the art. In certain embodiments, measurements may involve proprietary UE signaling facilitating the host computer 1502's measurements of throughput, propagation times, latency, and the like. The measurements may be implemented in that the software 1510 and 1540 causes messages to be transmitted, in particular empty or ‘dummy’ messages, using the OTT connection 1516 while it monitors propagation times, errors, etc.

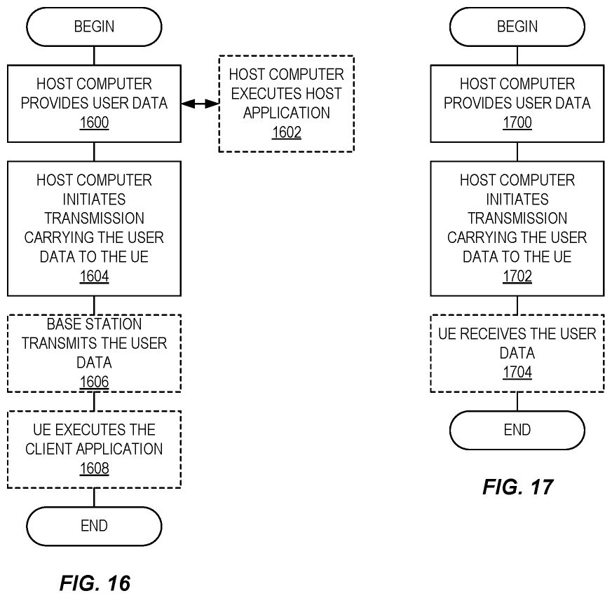

FIG. 16 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 16 will be included in this section. In step 1600, the host computer provides user data. In sub-step 1602 (which may be optional) of step 1600, the host computer provides the user data by executing a host application. In step 1604, the host computer initiates a transmission carrying the user data to the UE. In step 1606 (which may be optional), the base station transmits to the UE the user data which was carried in the transmission that the host computer initiated, in accordance with the teachings of the embodiments described throughout this disclosure. In step 1608 (which may also be optional), the UE executes a client application associated with the host application executed by the host computer.

FIG. 17 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 17 will be included in this section. In step 1700 of the method, the host computer provides user data. In an optional sub-step (not shown) the host computer provides the user data by executing a host application. In step 1702, the host computer initiates a transmission carrying the user data to the UE. The transmission may pass via the base station, in accordance with the teachings of the embodiments described throughout this disclosure. In step 1704 (which may be optional), the UE receives the user data carried in the transmission.

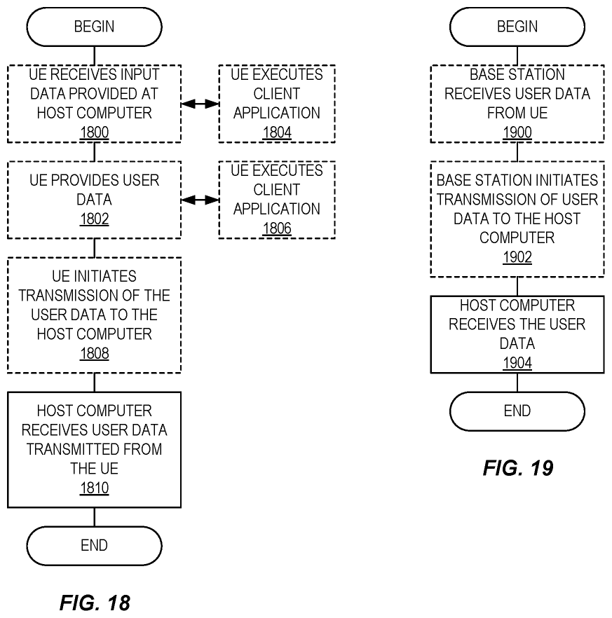

FIG. 18 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 18 will be included in this section. In step 1800 (which may be optional), the UE receives input data provided by the host computer. Additionally or alternatively, in step 1802, the UE provides user data. In sub-step 1804 (which may be optional) of step 1800, the UE provides the user data by executing a client application. In sub-step 1806 (which may be optional) of step 1802, the UE executes a client application which provides the user data in reaction to the received input data provided by the host computer. In providing the user data, the executed client application may further consider user input received from the user. Regardless of the specific manner in which the user data was provided, the UE initiates, in sub-step 1808 (which may be optional), transmission of the user data to the host computer. In step 1810 of the method, the host computer receives the user data transmitted from the UE, in accordance with the teachings of the embodiments described throughout this disclosure.

FIG. 19 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 19 will be included in this section. In step 1900 (which may be optional), in accordance with the teachings of the embodiments described throughout this disclosure, the base station receives user data from the UE. In step 1902 (which may be optional), the base station initiates transmission of the received user data to the host computer. In step 1904 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

### GROUP A EMBODIMENTS

Embodiment 1: A method performed by a wireless communication device, WCD, (212), the method comprising: obtaining (400, 600A, or 600B) Point A information to be used for one or more reference signals on a non-serving cell of the WCD (212), the Point A information being information about a frequency domain reference point; and applying (402, 602) the Point A information to receive (or transmit) one or more reference signals on the non-serving cell of the WCD (212).

Embodiment 2: The method of embodiment 1 wherein a Point A of the non-serving cell of the WCD (212) is different than a Point A of a serving cell of the WCD (212).

Embodiment 3: The method of embodiment 1 or 2 wherein the Point A information comprises a Point A of the non-serving cell.

Embodiment 4: The method of embodiment 1 or 2 wherein the Point A information comprises an offset between a Point A of the non-serving cell and a Point A of a serving cell of the WCD (212).

Embodiment 5: The method of embodiment 1 or 2 wherein the Point A information comprises a common Point A to be applied by the WCD (212) for both the non-serving cell of the WCD (212) and a serving cell of the WCD (212).

Embodiment 6: The method of embodiment 5 wherein a Point A of the non-serving cell of the WCD (212) is different than a Point A of a serving cell of the WCD (212), and the common Point A is different from the Point A of the non-serving cell, different from the Point A of the serving cell, or different from both the Point A of the non-serving cell and the Point A of the serving cell.

Embodiment 7: The method of any of embodiments 1 to 6 wherein obtaining (400, 600B) the Point A information to be used for one or more reference signals on a non-serving cell of the WCD (212) comprises receiving (400, 600B) the Point A information via signaling from a network node.

Embodiment 8: The method of embodiment 7 wherein the Point A information is signaled as part of a serving cell configuration of a serving cell of the WCD (212).

Embodiment 9: The method of embodiment 7 wherein the Point A information is signaled outside of a serving cell configuration of a serving cell of the WCD (212).

Embodiment 10: The method of embodiment 1 or 2 wherein the Point A information comprises a common Point A to be applied by the WCD (212) for both the non-serving cell of the WCD (212) and a serving cell of the WCD (212), and obtaining (600B) the Point A information to be used for one or more reference signals on a non-serving cell of the WCD (212) comprises determining (600B) the common Point A information.

Embodiment 11: The method of embodiment 10 wherein a Point A of the non-serving cell of the WCD (212) is different than a Point A of a serving cell of the WCD (212), and the common Point A is different from the Point A of the non-serving cell, different from the Point A of the serving cell, or different from both the Point A of the non-serving cell and the Point A of the serving cell.

Embodiment 12: The method of any of embodiments 1 to 11 wherein the one or more reference signals are one or more reference signals other than SSB.

Embodiment 13: The method of any of embodiments 1 to 12 wherein the one or more reference signals comprise CSI-RS, DMRS for PDCCH, DMRS for PDSCH, DMRS for PSSCH, and/or DMRS for PSSCH.

Embodiment 14: The method of any of the previous embodiments, further comprising: providing user data; and forwarding the user data to a host computer via the transmission to the base station.

### GROUP B EMBODIMENTS

Embodiment 15: A method performed by network node, the method comprising: signaling (400, 600B), to a WCD (212), Point A information to be used for one or more reference signals on a non-serving cell of the WCD (212), the Point A information being information about a frequency domain reference point.

Embodiment 16: The method of embodiment 15 wherein a Point A of the non-serving cell of the WCD (212) is different than a Point A of a serving cell of the WCD (212).

Embodiment 17: The method of embodiment 15 or 16 wherein the Point A information comprises a Point A of the non-serving cell.

Embodiment 18: The method of embodiment 15 or 16 wherein the Point A information comprises an offset between a Point A of the non-serving cell and a Point A of a serving cell of the WCD (212).

Embodiment 19: The method of embodiment 15 or 16 wherein the Point A information comprises a common Point A to be applied by the WCD (212) for both the non-serving cell of the WCD (212) and a serving cell of the WCD (212).

Embodiment 20: The method of embodiment 19 wherein a Point A of the non-serving cell of the WCD (212) is different than a Point A of a serving cell of the WCD (212), and the common Point A is different from the Point A of the non-serving cell, different from the Point A of the serving cell, or different from both the Point A of the non-serving cell and the Point A of the serving cell.

Embodiment 21: The method of any of embodiments 15 to 20 wherein the Point A information is signaled as part of a serving cell configuration of a serving cell of the WCD (212).

Embodiment 22: The method of any of embodiments 15 to 20 wherein the Point A information is signaled outside of a serving cell configuration of a serving cell of the WCD (212).

Embodiment 23: The method of any of embodiments 15 to 22 wherein the Point A information is for transmission (or reception) of one or more reference signals to (or from) the WCD (212) one the non-serving cell.

Embodiment 24: The method of embodiment 23 wherein the one or more reference signals are one or more reference signals other than SSB.

Embodiment 25: The method of embodiment 23 or 24 wherein the one or more reference signals comprise CSI-RS, DMRS for PDCCH, DMRS for PDSCH, DMRS for PSSCH, and/or DMRS for PSCCH.

Embodiment 26: A method performed by first network node associated to a serving cell of a WCD (212), the method comprising: signaling (800), to a second network node associated to a non-serving cell of the WCD (212), Point A information of the serving cell of the WCD (212), the Point A information being information about a frequency domain reference point.

Embodiment 27: A method performed by second network node associated to a non-serving cell of a WCD (212), the method comprising: receiving (800), from a first network node associated to a serving cell of the WCD (212), Point A information of the serving cell of the WCD (212), the Point A information being information about a frequency domain reference point; and applying (802) the Point A information of the serving cell of the WCD (212) when transmitting (or receiving) one or more reference signals to (or from) the WCD (212) on the non-serving cell of the WCD (212).

Embodiment 28: The method of embodiment 27 wherein the one or more reference signals are one or more reference signals other than SSB.

Embodiment 29: The method of embodiment 27 or 28 wherein the one or more reference signals comprise CSI-RS, DMRS for PDCCH, DMRS for PDSCH, DMRS for PSSCH, and/or DMRS for PSSCH.

Embodiment 30: The method of any of the previous embodiments, further comprising: obtaining user data; and forwarding the user data to a host computer or a wireless communication device.

### GROUP C EMBODIMENTS

Embodiment 31: A wireless communication device comprising: processing circuitry configured to perform any of the steps of any of the Group A embodiments; and power supply circuitry configured to supply power to the wireless communication device.

Embodiment 32: A base station comprising: processing circuitry configured to perform any of the steps of any of the Group B embodiments; and power supply circuitry configured to supply power to the base station.

Embodiment 33: A User Equipment, UE, comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 34: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 35: The communication system of the previous embodiment further including the base station.

Embodiment 36: The communication system of the previous 2 embodiments, further including the UE, wherein the UE is configured to communicate with the base station.

Embodiment 37: The communication system of the previous 3 embodiments, wherein: the processing circuitry of the host computer is configured to execute a host application, thereby providing the user data; and the UE comprises processing circuitry configured to execute a client application associated with the host application.

Embodiment 38: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 39: The method of the previous embodiment, further comprising, at the base station, transmitting the user data.

Embodiment 40: The method of the previous 2 embodiments, wherein the user data is provided at the host computer by executing a host application, the method further comprising, at the UE, executing a client application associated with the host application.

Embodiment 41: A User Equipment, UE, configured to communicate with a base station, the UE comprising a radio interface and processing circuitry configured to perform the method of the previous 3 embodiments.

Embodiment 42: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 43: The communication system of the previous embodiment, wherein the cellular network further includes a base station configured to communicate with the UE.

Embodiment 44: The communication system of the previous 2 embodiments, wherein: the processing circuitry of the host computer is configured to execute a host application, thereby providing the user data; and the UE's processing circuitry is configured to execute a client application associated with the host application.

Embodiment 45: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 46: The method of the previous embodiment, further comprising at the UE, receiving the user data from the base station.

Embodiment 47: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 48: The communication system of the previous embodiment, further including the UE.

Embodiment 49: The communication system of the previous 2 embodiments, further including the base station, wherein the base station comprises a radio interface configured to communicate with the UE and a communication interface configured to forward to the host computer the user data carried by a transmission from the UE to the base station.

Embodiment 50: The communication system of the previous 3 embodiments, wherein: the processing circuitry of the host computer is configured to execute a host application; and the UE's processing circuitry is configured to execute a client application associated with the host application, thereby providing the user data.

Embodiment 51: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 52: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 53: The method of the previous embodiment, further comprising, at the UE, providing the user data to the base station.

Embodiment 54: The method of the previous 2 embodiments, further comprising: at the UE, executing a client application, thereby providing the user data to be transmitted; and at the host computer, executing a host application associated with the client application.

Embodiment 55: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 56: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 57: The communication system of the previous embodiment further including the base station.

Embodiment 58: The communication system of the previous 2 embodiments, further including the UE, wherein the UE is configured to communicate with the base station.

Embodiment 59: The communication system of the previous 3 embodiments, wherein: the processing circuitry of the host computer is configured to execute a host application; and the UE is configured to execute a client application associated with the host application, thereby providing the user data to be received by the host computer.

Embodiment 60: A method implemented in a communication system including a host computer, a base station, and a User Equipment, UE, the method comprising: at the host computer, receiving, from the base station, user data originating from a transmission which the base station has received from the UE, wherein the UE performs P any of the steps of any of the Group A embodiments.

Embodiment 61: The method of the previous embodiment, further comprising at the base station, receiving the user data from the UE.

Embodiment 62: The method of the previous 2 embodiments, further comprising at the base station, initiating a transmission of the received user data to the host computer.

Those skilled in the art will recognize improvements and modifications to the embodiments of the present disclosure. All such improvements and modifications are considered within the scope of the concepts disclosed herein.

1. A method performed by a wireless communication device, WCD, the method comprising:
obtaining information about a frequency domain reference point to be used for one or more reference signals on a non-serving cell of the WCD; and
applying the information about the frequency domain reference point to be used for the one or more reference signals on the non-serving cell of the WCD to receive or transmit one or more reference signals on the non-serving cell of the WCD.

2. The method of claim 1 wherein a Synchronization Signal Block, SSB, frequency of the non-serving cell of the WCD is the same as a SSB frequency of a serving cell of the WCD.

3. The method of claim 2 wherein the serving cell of the WCD is a Special Cell, SpCell, of the WCD, a Primary Cell, PCell, of the WCD, a Primary Secondary Cell, PSCell, of the WCD, or a Secondary Cell, SCell, of the WCD.

4. The method of claim 1 wherein the frequency domain reference point to be used for the one or more reference signals on the non-serving cell of the WCD is a Point A to be used for the one or more reference signals on the non-serving cell of the WCD.

5. The method of claim 4 wherein a center subcarrier 0 of common resource block 0, CRB0, on the non-serving cell for a respective subcarrier spacing configuration coincides with the Point A to be used for the one or more reference signals on the non-serving cell of the WCD.

6. The method of claim 1 wherein the frequency domain reference point for the one or more reference signals on the non-serving cell of the WCD is different than a frequency domain reference point for the one or more reference signals on a serving cell of the WCD.

7. The method of claim 1 wherein the information about the frequency domain reference point to be used for the one or more reference signals on the non-serving cell of the WCD comprises the frequency domain reference point to be used for the one or more reference signals on the non-serving cell.

8. The method of claim 1 wherein the information about the frequency domain reference point to be used for the one or more reference signals on the non-serving cell of the WCD comprises an offset between the frequency domain reference point to be used for the one or more reference signals on the non-serving cell of the WCD and a frequency domain reference point to be used for the one or more reference signals on a serving cell of the WCD.

9. The method of claim 1 wherein the frequency domain reference point to be used for the one or more reference signals on the non-serving cell of the WCD is a common frequency domain reference point to be used for the one or more reference signals on both the non-serving cell of the WCD and a serving cell of the WCD.

10. The method of claim 9 wherein the common frequency domain reference point is a common Point A, a Point A of the non-serving cell of the WCD is different than a Point A of a serving cell of the WCD, and the common Point A is different from the Point A of the non-serving cell, different from the Point A of the serving cell, or different from both the Point A of the non-serving cell and the Point A of the serving cell.

11. The method of claim 1 wherein obtaining the information about the frequency domain reference point to be used for the one or more reference signals on the non-serving cell of the WCD comprises receiving the information about the frequency domain reference point to be used for the one or more reference signals on the non-serving cell of the WCD via signaling from a network node.

12. The method of claim 11 wherein the information about the frequency domain reference point to be used for the one or more reference signals on the non-serving cell of the WCD is signaled as part of a serving cell configuration of a serving cell of the WCD.

13. The method of claim 11 wherein the information about the frequency domain reference point to be used for the one or more reference signals on the non-serving cell of the WCD is signaled outside of a serving cell configuration of a serving cell of the WCD.

14. The method of claim 11 wherein the information about the frequency domain reference point to be used for the one or more reference signals on the non-serving cell of the WCD is signaled outside of a cell group configuration associated with a serving cell of the WCD.

15. The method of claim 1 wherein the information about the frequency domain reference point to be used for the one or more reference signals on the non-serving cell of the WCD comprises a common Point A to be applied by the WCD for both the non-serving cell of the WCD and a serving cell of the WCD, and obtaining the information about the frequency domain reference point to be used for the one or more reference signals on the non-serving cell of the WCD comprises determining the common Point A.

16. The method of claim 15 wherein a Point A of the non-serving cell of the WCD is different than a Point A of a serving cell of the WCD, and the common Point A is different from the Point A of the non-serving cell, different from the Point A of the serving cell, or different from both the Point A of the non-serving cell and the Point A of the serving cell.

17. The method of claim 1 wherein the one or more reference signals are one or more reference signals other than a Synchronization Signal Block, SSB.

18. The method of claim 1 wherein the one or more reference signals comprise:
(a) a Channel State Information Reference Signal, CSI-RS;
(b) a Demodulation Reference Signal, DMRS, for a Physical Downlink Control Channel, PDCCH;
(c) DMRS for a Physical Downlink Shared Channel, PDSCH;
(d) DMRS for a Physical Sidelink Shared Channel, PSSCH;
(e) DMRS for a Physical Sidelink Control Channel, PSCCH; or
(f) any combination of two or more of (a)-(e).

19. (canceled)

20. (canceled)

21. A wireless communication device, WCD, comprising:
one or more transmitters;
one or more receivers; and
processing circuitry associated with the one or more transmitters and the one or more receivers, the processing circuitry configured to cause the WCD to:
obtain information about a frequency domain reference point to be used for one or more reference signals on a non-serving cell of the WCD; and
apply the information about the frequency domain reference point to be used for the one or more reference signals on the non-serving cell of the WCD to receive or transmit one or more reference signals on the non-serving cell of the WCD.

22. (canceled)

23. A method performed by a network node, the method comprising:
signaling, to a wireless communication device, WCD, information about a frequency domain reference point to be used for one or more reference signals on a non-serving cell of the WCD.

24. The method of claim 23 wherein the frequency domain reference point to be used for the one or more reference signals on the non-serving cell of the WCD is a Point A to be used for the one or more reference signals on the non-serving cell of the WCD.

25. The method of claim 24 wherein a center subcarrier 0 of common resource block 0, CRB0, on the non-serving cell for a respective subcarrier spacing configuration coincides with the Point A to be used for the one or more reference signals on the non-serving cell of the WCD.

26. The method of claim 23 wherein the frequency domain reference point for the one or more reference signals on the non-serving cell of the WCD is different than a frequency domain reference point for the one or more reference signals on a serving cell of the WCD.

27-38. (canceled)

39. A network node comprising processing circuitry configured to cause the network node to:
signal, to a wireless communication device, WCD, information about a frequency domain reference point to be used for one or more reference signals on a non-serving cell of the WCD.

40. (canceled)

41. A method performed by first network node associated to a serving cell of a wireless communication device, WCD, the method comprising:
signaling, to a second network node associated to a non-serving cell of the WCD, information about a frequency domain reference point to be used for one or more reference signals on the serving cell of the WCD.

42. (canceled)

43. (canceled)

44. A method performed by a second network node associated to a non-serving cell of a wireless communication device, WCD, the method comprising:
receiving, from a first network node associated to a serving cell of the WCD, information about a frequency domain reference point to be used for one or more reference signals on the serving cell of the WCD; and
applying the information about the frequency domain reference point to be used for the one or more reference signals on the serving cell of the WCD when transmitting or receiving one or more reference signals to or from the WCD on the non-serving cell of the WCD.

45-48. (canceled)
